(19) United States
(12) Patent Application Publication
(10) Pub. No.: US 2026/0205944 A1
(43) Pub. Date: Jul. 16, 2026

(54) EFFICIENT WAY OF TWT OVERLAPPING

(71) Applicant: QUALCOMM Incorporated, San Diego, CA (US)

(72) Inventors: Xin WU, Shanghai (CN); Daqing LI, Suzhou, Jiangsu (CN); Feng CHEN, Shanghai (CN); Junqi MIAO, Shanghai (CN); Linghui WU, Shanghai (CN)

(21) Appl. No.: 19/128,983

(22) PCT Filed: Jan. 12, 2023
(86) PCT No.: PCT/CN2023/071847

§ 371 Date: May 9, 2025

(51) Int. Cl. H04W 52/02; H04W 72/0446; H04W 72/566

(52) U.S. Cl. CPC H04W 52/0216; H04W 72/0446; H04W 72/569

(57) ABSTRACT

This disclosure provides methods, components, devices, and systems for wireless communication involving utilizing a service period (SP) margin added at an end of a SP. Some aspects more specifically relate to transmitting data packets during an overlapped time period between SPs of two adjacent TWTs. In some examples, an access point (AP) may transmit a frame including a TWT element indicating a first scheduled SP associated with a first wireless communication device, the first scheduled SP having an overlapping time period with a portion of a second scheduled SP associated with a second wireless communication device. By utilizing the overlapping time period, aspects of the present disclosure may more efficiently transmit or receive data during the service period margin in the overlapping time period. Aspects of the present disclosure may result in a higher efficiency of use for a SP margin and lead to higher efficiency of bandwidth.

### TECHNICAL FIELD

This disclosure relates generally to wireless communication, and more specifically, to wireless communication utilizing overlapping service periods (SPs) of different Target Wait Times (TWTs).

### DESCRIPTION OF THE RELATED TECHNOLOGY

A wireless local area network (WLAN) may be formed by one or more access points (APs) that provide a shared wireless communication medium for use by a number of client devices also referred to as stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some WLANs, a target wait time (TWT) is a function that permits an AP to define a specific time or set of times for individual stations to access the transmission medium. The wireless stations and the AP exchange information that includes an expected transmit (Tx)/receive (Rx) activity duration to allow the AP to control the amount of contention and overlap among competing wireless stations. The use of TWT may be negotiated between an AP and a wireless station or may be broadcasted by the AP to one or more wireless stations that may be associated or unassociated with the AP. TWT may be used to reduce network energy consumption because wireless stations that use it can enter a doze state until their TWT service period (SP) arrives. Wireless stations wake up (power on or enter an active state) during the allocated TWT SP and may be in a doze state (power off or enter an inactive state) outside of the TWT.

Power save (PS) devices may be devices such as an AP and/or wireless stations and also may be referred to as user devices. PS devices may utilize power saving modes in order to increase the efficiency and flexibility of data transmission. Specifically, the PS device may doze (enter an inactive state or power off) between packets to save power, while the AP buffers downlink frames that typically would have been sent to the PS device. The PS device and/or the AP determine the time when the PS devices should wake up (enter an active state or power on) and receive data packets to maximize power conservation without sacrificing quality of service (QoS).

### SUMMARY

The systems, methods and devices of this disclosure each have several innovative aspects, no single one of which is solely responsible for the desirable attributes disclosed herein.

One innovative aspect of the subject matter described in this disclosure can be implemented in a wireless communication device. The wireless communication device includes at least one memory; and at least one processor communicatively coupled with the at least one memory, the at least one processor operable to cause the wireless communication device to: transmit a frame including a target wake time (TWT) element indicating a first scheduled service period (SP) associated with a first wireless communication device, the first scheduled SP having an overlapping time period with a portion of a second scheduled SP associated with a second wireless communication device, and transmit or receive data during the overlapping time period.

Another innovative aspect of the subject matter described in this disclosure can be implemented in a method for wireless communication. The method includes transmitting a frame including a TWT element indicating a first scheduled SP associated with a first wireless communication device, the first scheduled SP having an overlapping time period with a portion of a second scheduled SP associated with a second wireless communication device; and transmitting or receiving data during the overlapping time period.

Another innovative aspect of the subject matter described in this disclosure can be implemented in a wireless communication device. The wireless communication device includes at least one memory; and at least one processor communicatively coupled with the at least one memory, the at least one processor operable to cause the wireless communication device to: receive a frame including a TWT element indicating a first scheduled SP associated with an apparatus, the first scheduled SP having an overlapping time period with a portion of a second scheduled SP associated with a second wireless communication device, and transmit or receive data during the overlapping time period.

Another innovative aspect of the subject matter described in this disclosure can be implemented in a method for wireless communication. The method includes receiving a frame including a TWT element indicating a first scheduled SP associated with an apparatus, the first scheduled SP having an overlapping time period with a portion of a second scheduled SP associated with a second wireless communication device; and transmitting or receiving data during the overlapping time period.

In some examples, the methods and wireless communication devices may implement a packet conflicting resolution mechanism within the overlapping time period by defining a TWT priority for each TWT such that data packets with a higher TWT priority are sent ahead of those with lower TWT priority.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a block diagram of an example wireless communication device that supports TWT overlapping.

FIG. 3 shows a block diagram of an example wireless communication device that supports TWT overlapping.

FIG. 4 shows a pictorial diagram of examples of different SP intervals.

FIG. 5 shows a pictorial diagram of an example of an SP margin used for re-transmission.

FIG. 6 shows a pictorial diagram of an example of an SP interval with two target wait times (TWTs) adjacent to one another but that do not overlap.

FIG. 7 shows a pictorial diagram of examples of a wireless communication with two TWTs and three stations (STAs).

FIG. 8 shows a pictorial diagram of an example of a SP interval with two target wait times (TWTs) with an overlapping portion.

FIG. 9 shows a pictorial diagram illustrating a comparison of an SP interval with overlapped TWTs and non-overlapped TWTs.

FIG. 10 shows a pictorial diagram illustrating a comparison of TWT allocation in a beacon interval for non-overlapped TWT and overlapped TWT.

FIG. 11 shows a pictorial diagram illustrating a TWT element for defining a presence of overlapped TWT.

FIG. 12 shows a pictorial diagram illustrating a TWT element for defining overlapped TWT information.

FIG. 13 shows a pictorial diagram illustrating an example of adding TWT priority update information in frames.

FIG. 14 shows a pictorial diagram illustrating an example of using TWT priority updates in frames with a scheduled termination of SP.

FIG. 15 shows a pictorial diagram illustrating an example of using TWT priority updates in frames with an early termination of SP.

FIG. 16 shows a flowchart illustrating an example process performable by a wireless AP that supports overlapping TWTs.

FIG. 17 shows a flowchart illustrating an example process performable by a wireless AP that supports overlapping TWTs.

FIG. 18 shows a flowchart illustrating an example process performable by a wireless STA that supports overlapping TWTs.

FIG. 19 shows a flowchart illustrating an example process performable by a wireless STA that supports overlapping TWTs.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

Various aspects relate generally to wireless communication and more generally to utilizing service period (SP) margins for target wake times (TWTs). Some aspects more specifically relate to utilizing an overlapped time period between SPs of two adjacent TWTs. In some examples, an access point (AP) may transmit a frame including a TWT element indicating a first scheduled SP associated with a first wireless communication device, the first scheduled SP having an overlapping time period with a portion of a second scheduled SP associated with a second wireless communication device. By utilizing the overlapping time period, an AP may more efficiently transmit or receive data during the overlapping time period. As a result, an SP margin (or the overlapping time period) at the end of an SP may be efficiently used by wireless stations. In addition, the overlapping time period can also save additional time periods for other wireless stations (STAs) to access. For example, the saved time period may be as long as a duration of the SP margin. Similarly, more TWT groups may be allocated in a same time period with a same number of STAs such that using the same time period provides less traffic conflicts. By utilizing an overlapping time period between a first scheduled SP and a second scheduled SP, aspects of the present disclosure may result in a higher efficiency of use for a SP margin in the overlapping time period and lead to higher efficiency of bandwidth.

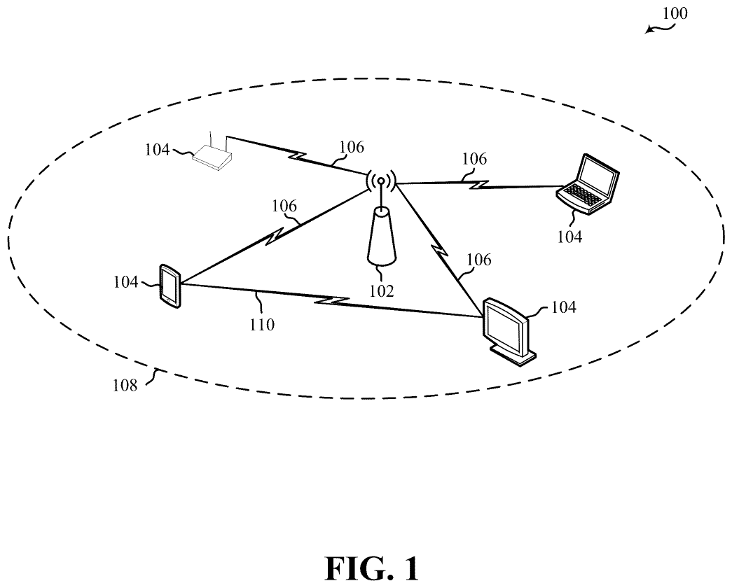

FIG. 1 shows a pictorial diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2020 specification or amendments thereof including, but not limited to, 802.11ay, 802.11ax, 802.11az, 802.11ba, 802.11bd, 802.11be, 802.11bf, and the 802.11 amendment associated with Wi-Fi 8). The WLAN 100 may include numerous wireless communication devices such as a wireless AP 102 and multiple wireless STAs 104. While only one AP 102 is shown in FIG. 1, the WLAN network 100 also can include multiple APs 102. AP 102 shown in FIG. 1 can represent various different types of APs including but not limited to enterprise-level APs, single-frequency APs, dual-band APs, standalone APs, software-enabled APs (soft APs), and multi-link APs. The coverage area and capacity of a cellular network (such as LTE, 5G NR, etc.) can be further improved by a small cell which is supported by an AP serving as a miniature base station. Furthermore, private cellular networks also can be set up through a wireless area network using small cells.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, chromebooks, extended reality (XR) headsets, wearable devices, display devices (for example, TVs (including smart TVs), computer monitors, navigation systems, among others), music or other audio or stereo devices, remote control devices (“remotes”), printers, kitchen appliances (including smart refrigerators) or other household appliances, key fobs (for example, for passive keyless entry and start (PKES) systems), Internet of Things (IoT) devices, and vehicles, among other examples. The various STAs 104 in the network are able to communicate with one another via the AP 102.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the WLAN 100. The BSS may be identified or indicated to users by a service set identifier (SSID), as well as to other devices by a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to one or more of the IEEE 802.11 family of wireless communication protocol standards. These standards define the WLAN radio and baseband protocols for the PHY and MAC layers. The APs 102 and STAs 104 transmit and receive wireless communications (hereinafter also referred to as “Wi-Fi communications” or “wireless packets”) to and from one another in the form of PHY protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some examples of the APs 102 and STAs 104 described herein also may communicate in other frequency bands, such as the 5.9 GHz and the 6 GHz bands, which may support both licensed and unlicensed communications. The APs 102 and STAs 104 also can communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4, 5 GHz or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload.

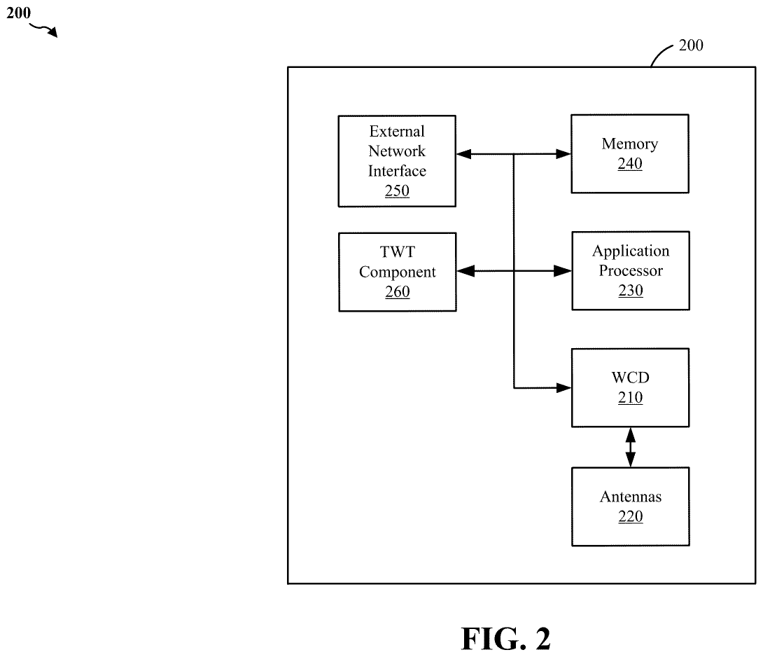

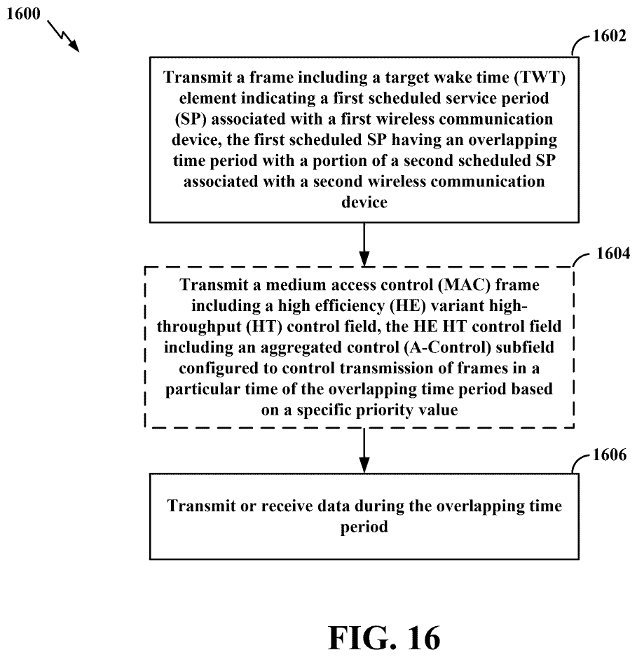

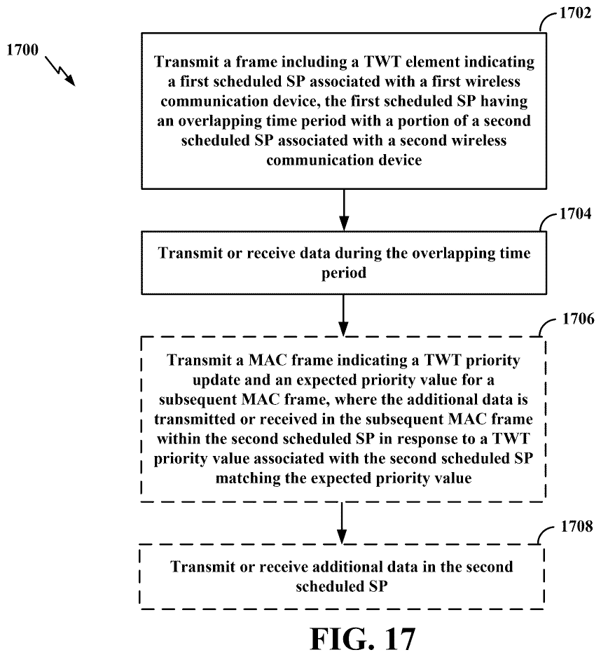

FIG. 2 shows a block diagram of an example wireless communication device 200 that supports TWT overlapping according to some aspects of the present disclosure. In some examples, the wireless communication device 200 is configured or operable to perform the process 1600 described with reference to FIG. 16 and process 1700 described with reference to FIG. 17. In various examples, the wireless communication device 200 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

For example, the wireless communication device 200 can be an example aspect of the AP 102 described with reference to FIG. 1. The wireless communication device 200 includes a wireless communication device (WCD) 210 (although the wireless communication device 200 may itself also be referred to generally as a wireless communication device as used herein). For example, the WCD 210 may be an example aspect of the wireless communication device 200 described with reference to FIG. 2. In some examples, the wireless communication device 200 or WCD 210 is configured or operable to perform the process 1600 described with reference to FIG. 16 and the process 1700 described with reference to FIG. 17. The wireless communication device 200 also includes multiple antennas 220 coupled with the WCD 210 to transmit and receive wireless communications. In some examples, wireless communication device 200 additionally includes an application processor 230 coupled with the WCD 210, and a memory 240 coupled with the application processor 230. The wireless communication device 200 further includes at least one external network interface 250 that enables the wireless communication device 200 to communicate with a core network or backhaul network to gain access to external networks including the Internet. For example, the external network interface 250 may include one or both of a wired (for example, Ethernet) network interface and a wireless network interface (such as a WWAN interface). Ones of the aforementioned components can communicate with other ones of the components directly or indirectly, over at least one bus. The wireless communication device 200 further includes a housing that encompasses the WCD 210, the application processor 230, the memory 240, and at least portions of the antennas 220 and external network interface 250.

The wireless communication device 200 or WCD 210 includes a TWT component 260. Portions of one or more of the component 260 may be implemented at least in part in hardware or firmware. For example, the TWT component 260 may be implemented at least in part by a modem. In some examples, at least some of the component 260 is implemented at least in part by a processor and as software stored in a memory. For example, portions of one or more of the component 260 can be implemented as non-transitory instructions (or “code”) executable by the processor to perform the functions or operations of the respective module.

In some implementations, the processor may be a component of a processing system. A processing system may generally refer to a system or series of machines or components that receives inputs and processes the inputs to produce a set of outputs (which may be passed to other systems or components of, for example, the wireless communication device 200 or WCD 210). For example, a processing system of the wireless communication device 200 or WCD 210 may refer to a system including the various other components or subcomponents of the wireless communication device 200 or WCD 210, such as the processor, or a transceiver, or a communications manager, or other components or combinations of components of the wireless communication device 200 or WCD 210. The processing system of the wireless communication device 200 or WCD 210 may interface with other components of the wireless communication device 200 or WCD 210, and may process information received from other components (such as inputs or signals) or output information to other components. For example, a chip or modem of the wireless communication device 200 or WCD 210 may include a processing system, a first interface to output information and a second interface to obtain information. In some implementations, the first interface may refer to an interface between the processing system of the chip or modem and a transmitter, such that the wireless communication device 200 or WCD 210 may transmit information output from the chip or modem. In some implementations, the second interface may refer to an interface between the processing system of the chip or modem and a receiver, such that the wireless communication device 200 or WCD 210 may obtain information or signal inputs, and the information may be passed to the processing system. A person having ordinary skill in the art will readily recognize that the first interface also may obtain information or signal inputs, and the second interface also may output information or signal outputs.

The TWT component 260 is capable of, configured to, or operable to transmit a frame including a TWT element indicating a first scheduled SP associated with a first wireless STA, the first scheduled SP having an overlapping time period with a portion of a second scheduled SP associated with a second wireless STA.

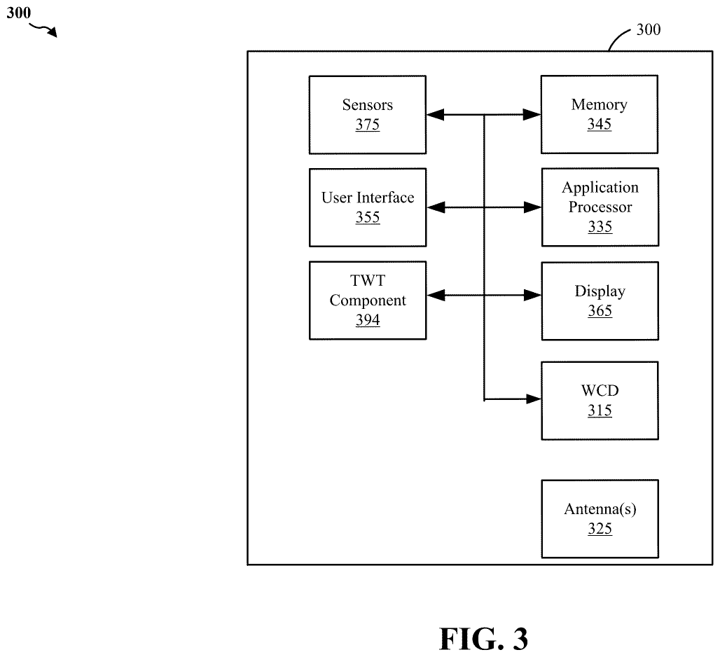

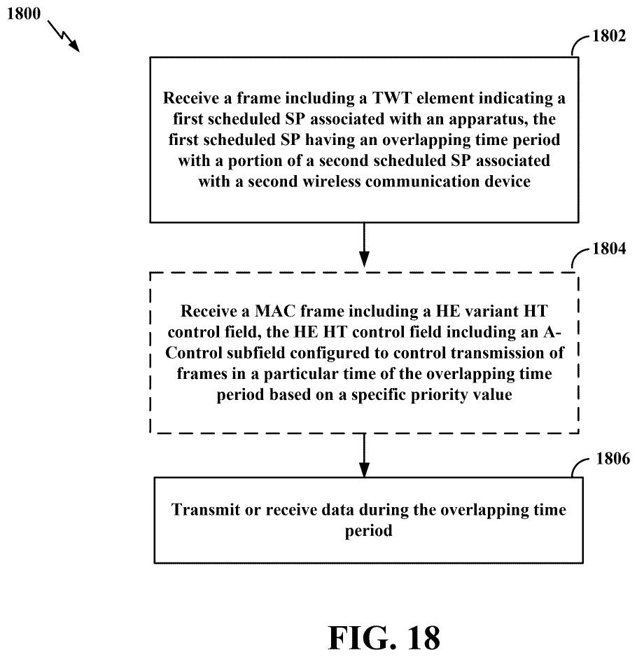

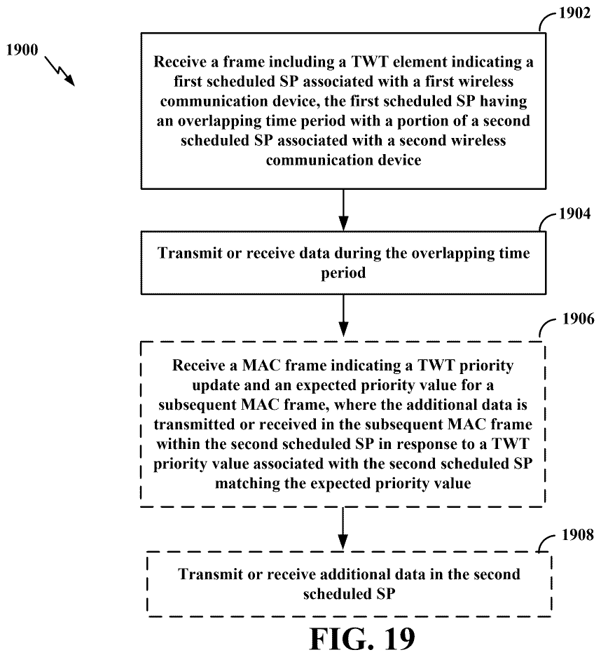

FIG. 3 shows a block diagram of an example wireless communication device 300 that supports TWT overlapping according to some aspects of the present disclosure. In some examples, the wireless communication device 300 is configured or operable to perform the process 1800 described with reference to FIG. 18 and process 1900 described with reference to FIG. 19. For example, the wireless communication device 300 can be an example aspect of the STA 104 described with reference to FIG. 1. The wireless communication device 300 includes a WCD 315 (although the wireless communication device 300 may itself also be referred to generally as a wireless communication device as used herein). In some examples, the wireless communication device 300 or WCD 315 is configured or operable to perform the process 1800 shown in FIG. 18 and the process 1900 shown in FIG. 19. The wireless communication device 300 also includes one or more antennas 325 coupled with the WCD 315 to transmit and receive wireless communications. In some examples, the wireless communication device 300 or WCD 315 additionally includes or can be coupled with an application processor 335 which may be further coupled with a memory 345. In some examples, the wireless communication device 300 or WCD 315 further includes a user interface (UI) 355 (such as a touchscreen or keypad) and a display 365, which may be integrated with the UI 355 to form a touchscreen display. In some aspects, the wireless communication device 300 or WCD 315 may further include one or more sensors 375 such as, for example, one or more inertial sensors, accelerometers, temperature sensors, pressure sensors, or altitude sensors. Ones of the aforementioned components can communicate with other ones of the components directly or indirectly, over at least one bus. The wireless communication device 300 further includes a housing that encompasses the WCD 315, the application processor 335, the memory 345, and at least portions of the antennas 325, UI 355, and display 365.

The wireless communication device 300 or WCD 315 includes a TWT component 394. Portions of one or more of the TWT component 394 may be implemented at least in part in hardware or firmware. For example, the TWT component 394 may be implemented at least in part by a modem. In some examples, at least some of the component 394 is implemented at least in part by a processor and as software stored in a memory. For example, portions of one or more of the components 394 can be implemented as non-transitory instructions (or “code”) executable by the processor to perform the functions or operations of the respective module.

In some implementations, the processor may be a component of a processing system. A processing system may generally refer to a system or series of machines or components that receives inputs and processes the inputs to produce a set of outputs (which may be passed to other systems or components of, for example, the wireless communication device 300 or WCD 315). For example, a processing system of the wireless communication device 300 or WCD 315 may refer to a system including the various other components or subcomponents of the wireless communication device 300 or WCD 315, such as the processor, or a transceiver, or a communications manager, or other components or combinations of components of the wireless communication device 300 or WCD 315. The processing system of the wireless communication device 300 or WCD 315 may interface with other components of the wireless communication device 300 or WCD 315, and may process information received from other components (such as inputs or signals) or output information to other components. For example, a chip or modem of the wireless communication device 300 or WCD 315 may include a processing system, a first interface to output information and a second interface to obtain information. In some implementations, the first interface may refer to an interface between the processing system of the chip or modem and a transmitter, such that the wireless communication device 300 or WCD 315 may transmit information output from the chip or modem. In some implementations, the second interface may refer to an interface between the processing system of the chip or modem and a receiver, such that the wireless communication device 300 or WCD 315 may obtain information or signal inputs, and the information may be passed to the processing system. A person having ordinary skill in the art will readily recognize that the first interface also may obtain information or signal inputs, and the second interface also may output information or signal outputs.

The TWT component 394 is capable of, configured to, or operable to receive a frame including a TWT element indicating a first scheduled SP associated with an access point, the first scheduled SP having an overlapping time period with a portion of a second scheduled SP associated with a second wireless station.

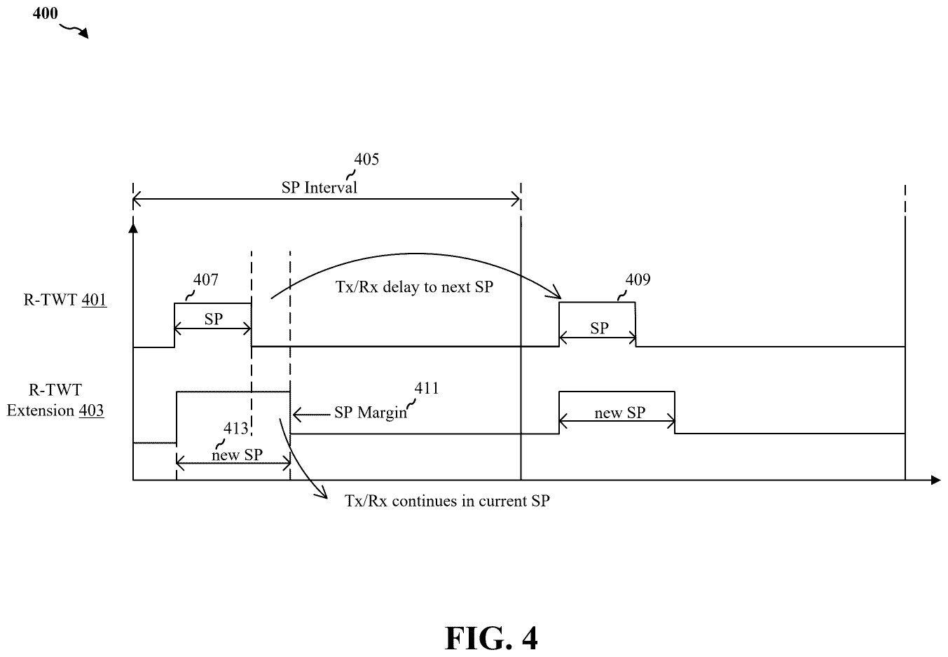

FIG. 4 shows a pictorial diagram 400 of examples of different SP intervals according to some aspects of the present disclosure. Generally, a restricted (R)-TWT may be used for low latency services, which provides better low latency performance than TWT. The start point of R-TWT 401 may be guaranteed by broadcasting the information of R-TWT 401. This means that any other base station subsystem (BSS) STAs terminate Tx/Rx activities before a start time of R-TWT 401. However, there is no guarantee that any planned low latency packets may all be sent out before the end of the SP 407 in the R-TWT 401 within the SP interval 405. For instance, there may be a few different types of Tx/Rx activities that may extend into the end of the SP 407 of R-TWT 401 such as retries, Modulation Coding Scheme (MCS) changes into lower rate, or channel access delay. To address this issue, there may be a few different options such as postponing the delayed packet to a subsequent SP or adding a SP margin to create a longer SP.

R-TWT 401 involves postponing the delayed packet to the next SP 409. Here, the Tx/Rx activity may be delayed to the next SP 409 since the Tx/Rx activity may not completely be sent out before the end of the SP 407. However, delaying these Tx/Rx activities that are likely to extend past the end of the current SP 407 into the next SP 409 will result in higher latency.

R-TWT Extension 403 involves adding a SP margin 411 to create a longer new SP 413. Here, the Tx/Rx activity may continue in the SP margin 411 within the SP interval 405 to achieve low latency since the longer new SP 413 is expected to cover these exceptional cases.

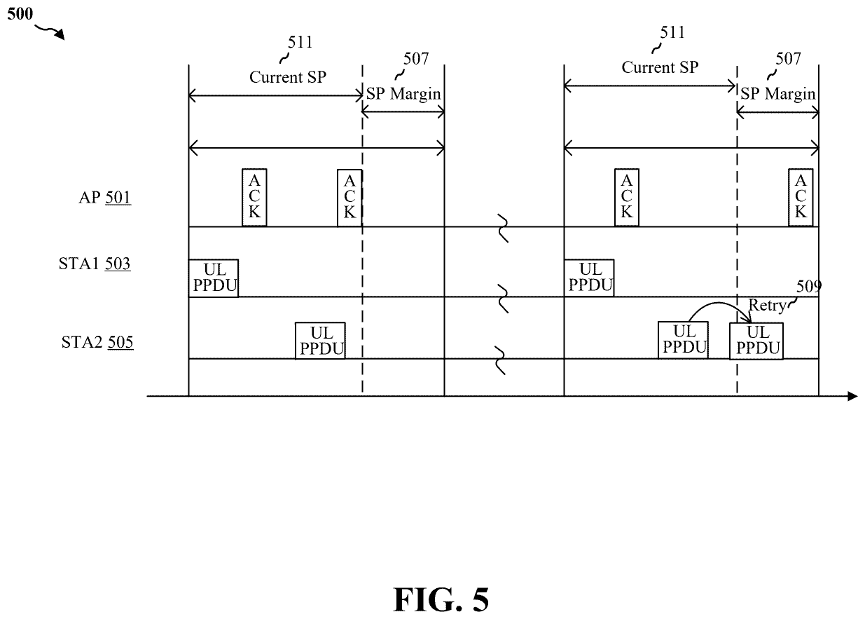

FIG. 5 shows a pictorial diagram 500 of an example of a SP margin used for re-transmission according to some aspects of the present disclosure. FIG. 5 shows an example where the SP margin 507 is utilized in order for STA2 505 to retry its data packet to the AP 501 and the data packet will occupy some time of the SP margin 507 during the retry. Specifically, STA2 505 retries 509 sending a packet immediately after the current SP 511 ends for STA1 503.

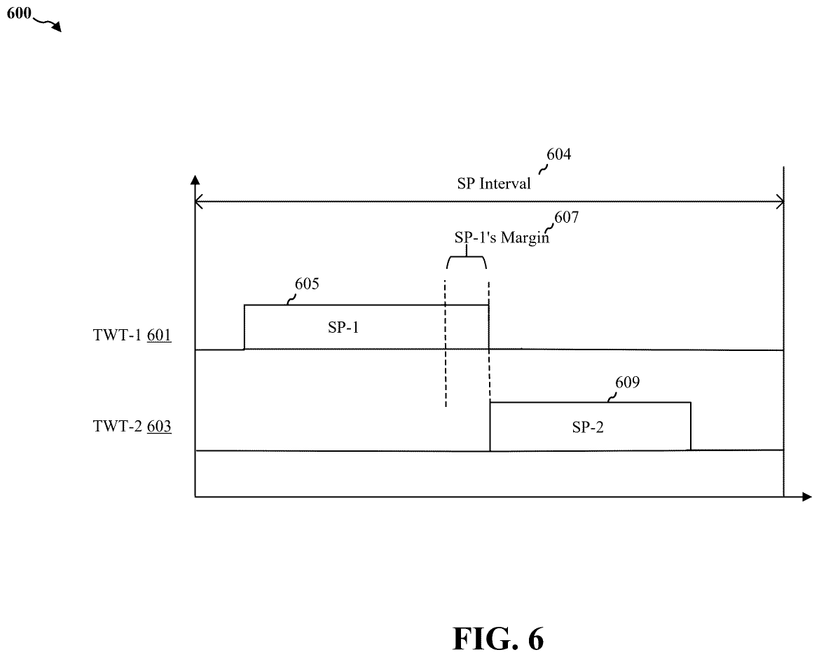

FIG. 6 is a pictorial diagram 600 of an example of an SP interval 604 with two TWTs 601 and 603 adjacent to one another but that do not overlap according to some aspects of the present disclosure. Here, the SP of TWT-1 601 includes SP-1 605 and a SP margin 607 and the SP of TWT-2 603 includes SP-2 609.

As explained above in FIGS. 4 and 5, low latency is guaranteed when the SP margin 607 is added to the end of SP-1 605 for TWT-1 601. However, there are some undesirable side effects of having a SP margin. For instance, there may be very few data packets that can be sent during the SP margin 607 for STAs of TWT-1 601 due to the short interval, which leads to low efficient usage of the time period. A reason for the low efficient usage is that, in a majority of the cases, STAs of TWT-1 601 can typically complete Tx/Rx ahead of the end of the SP margin 607, which means that the SP margin 607 cannot be utilized for a majority of the time. Another reason is that when two adjacent SPs are not overlapped, STAs of other TWTs cannot use the SP margin 607 for Tx/Rx activities even though the SP margin 607 is vacant. For example, as shown in FIG. 6, the SP margin 607 can only be used for Tx/Rx activities for STAs of TWT-1 601 and cannot be used for Tx/Rx activities for STAs of TWT-2 603.

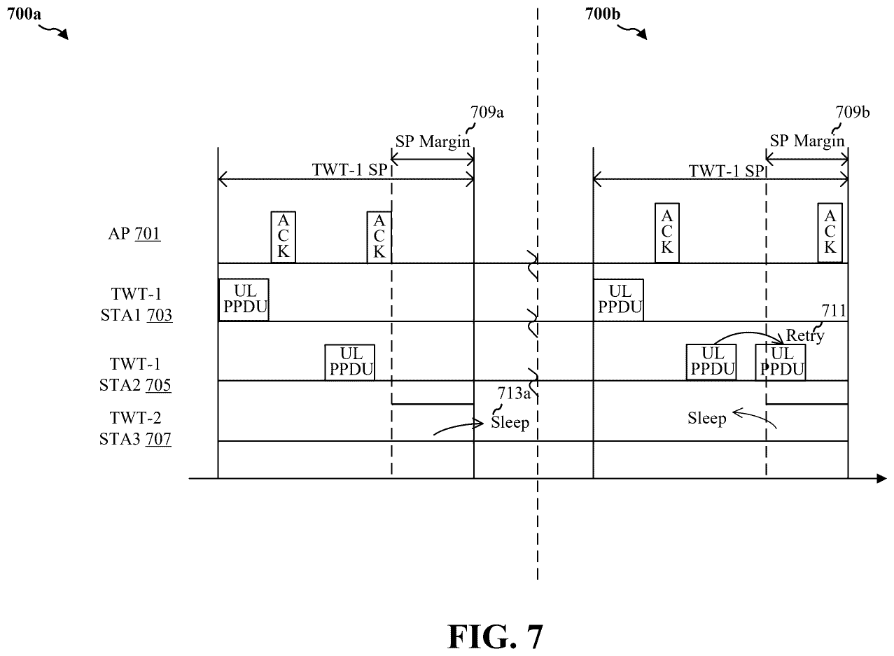

FIG. 7 shows a pictorial diagram of examples 700a, and 700b of a wireless communication with two TWTs and three STAs according to some aspects of the present disclosure. As shown in the example 700a of FIG. 7, shows three STAs (TWT-1 STA1 703, TWT-1 STA2 705, TWT-2 STA3 707) and TWT-1 STA2 705 retrying 711 its data packet to the AP 701 such that data packet occupies time in the SP margin 709b. As shown in the example 700b of FIG. 7, the wireless STA in TWT-2 STA3 707 cannot use SP Margin 709a of TWT-1 even though the SP margin 709a of TWT-1 SP is vacant. Instead, TWT-2 STA3 707 enters a sleep mode 713a during the vacant SP margin.

Accordingly, it would be helpful if there were more efficient ways to utilize the SP-1 margin.

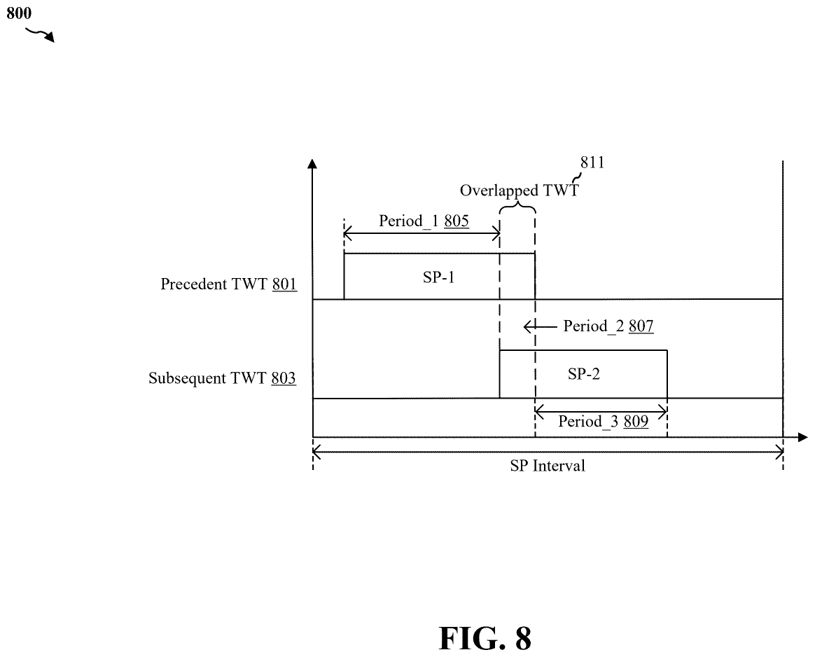

FIG. 8 shows a pictorial diagram 800 of an example of a SP interval with two adjacent TWTs 801, and 803 with an overlapping portion according to some aspects of the present disclosure. Unlike FIG. 6, FIG. 8 shows an example of two adjacent TWTs (precedent TWT 801 and subsequent TWT 803) with a portion that overlaps with each other.

The SP (SP-1) of precedent TWT 801 is composed of period 1 805 and a SP margin in period 2 807. The SP (SP-2) of subsequent TWT 803 is composed of period 2 807 and period 3 809, where period 2 807 forms an overlapped TWT 811 with SP-1. As shown in FIG. 8, the SPs of the precedent TWT 801 and the subsequent TWT 803 have a small part of a time period (the overlapped TWT 811) in their respective SPs that overlap with each other. The precedent TWT 801 has a lower latency requirement than subsequent TWT 803.

For a majority of cases, STAs of precedent TWT 801 can complete Tx/Rx activity in period 1 805 and then STAs of subsequent TWT 803 may begin Tx in period 2 807 once the STAs of the subsequent TWT 803 receive a notification event of an early termination of SP-1. In some cases, STAs of precedent TWT 801 extend Tx/Rx activity past the period 1 805 into period 2 807 (or the overlapped TWT 811). In these cases, the STAs of subsequent TWT 803 will delay Tx until after the Tx/Rx completion of precedent TWT 801 since STAs of precedent TWT 801 have a higher priority to perform Tx/Rx activities than STAs of subsequent TWT 803 within the overlapped TWT 811.

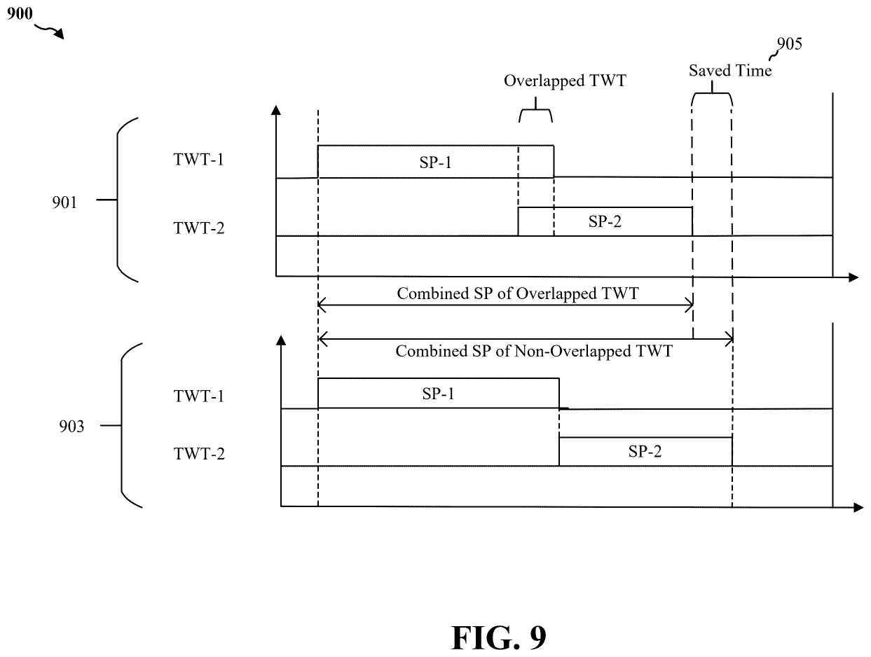

FIG. 9 shows a pictorial diagram 900 illustrating a comparison of an example of an SP interval with overlapped TWTs 901 and an example of an non-overlapped TWTs 903 according to some aspects of the present disclosure. In addition to a more efficient usage of the SP margin, the example of an SP interval with overlapped TWTs 901 can also save at least an additional time period for other STAs to access as compared to the example of an non-overlapped TWTs 903. As shown in FIG. 9, in a combined SP of non-overlapped TWT, the saved time period 905 may be as long as a time period of the SP margin.

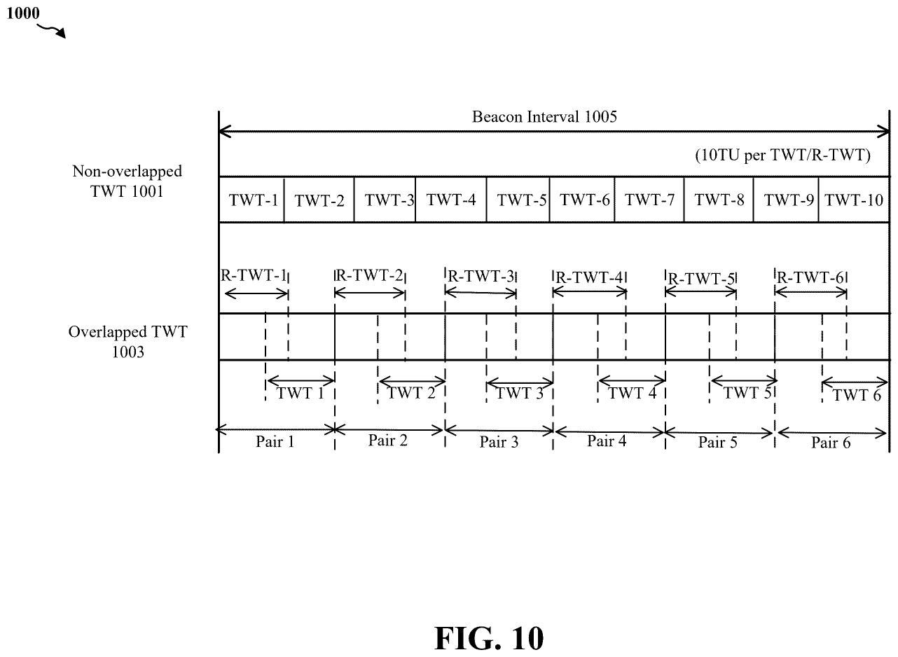

FIG. 10 shows a pictorial diagram 1000 illustrating a comparison of TWT allocation in a beacon interval 1005 for a non-overlapped TWT scenario 1001 and an overlapped TWT scenario 1003 according to some aspects of the present disclosure. By saving at least an additional time period for other STAs to access in the SP interval, more TWT groups may be allocated in the same time period. As shown in FIG. 10, in a beacon interval 1005 for the non-overlapped TWT scenario 1001, there are a total of 10 TWT groups per TWT/R-TWT in the beacon interval 1005. However, in the beacon interval 1005 for the overlapped TWT scenario 1003, there are a total of 12 TWT groups per TWT/R-TWT. This shows that with a same number of STAs and a same time period, a beacon interval may have more TWT groups which will result in less traffic conflicts.

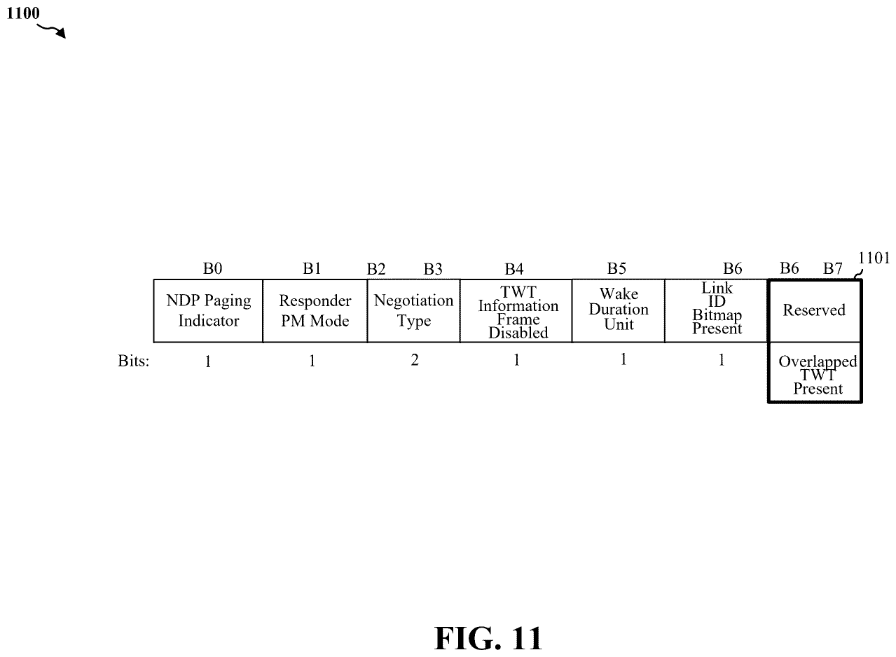

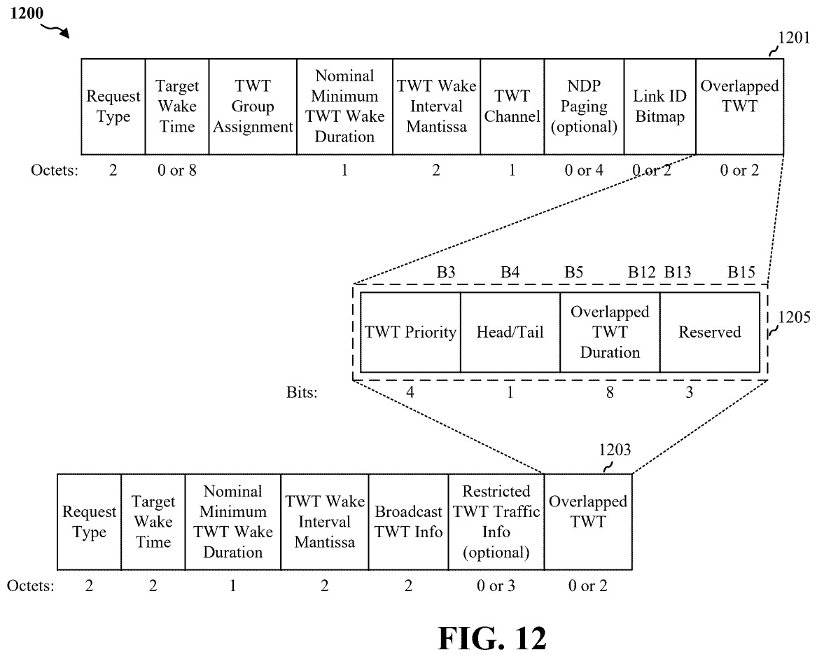

FIG. 11 shows a pictorial diagram 1100 illustrating a TWT element for defining a presence of overlapped TWT according to some aspects of the present disclosure. As shown in FIG. 11, the reserved bit B7 1101 of a control field may be used to indicate presence of a overlapped TWT using bits. In some examples, if the reserved bit B7 1101 is set to 1 then the Individual/Broadcast TWT (shown in FIG. 12) has a 2-byte overlapped TWT field. In some examples, if the reserved bit B7 is set to 0 then the Individual/Broadcast TWT does not have a 2-byte overlapped TWT field.

FIG. 12 shows a pictorial diagram 1200 illustrating a TWT element for defining overlapped TWT information according to some aspects of the present disclosure. As shown in FIG. 12, the overlapped TWT field format 1205 may be indicated in either an Individual TWT Parameter Set field format 1201 or a Broadcast TWT Parameter Set field format 1203. The overlapped TWT field format 1205 may include a field (TWT Priority) indicating a priority value for resolving packet conflicts during the overlapped time period, a field (Head/Tail) indicating whether the overlapping time period is at a beginning of a first scheduled SP or at an end of the first scheduled SP, and a field (Overlapped TWT Duration) indicating a time duration of the overlapping time period. In some aspects, the time duration has a same time unit as “Wake Duration Unit” in the same TWT element.

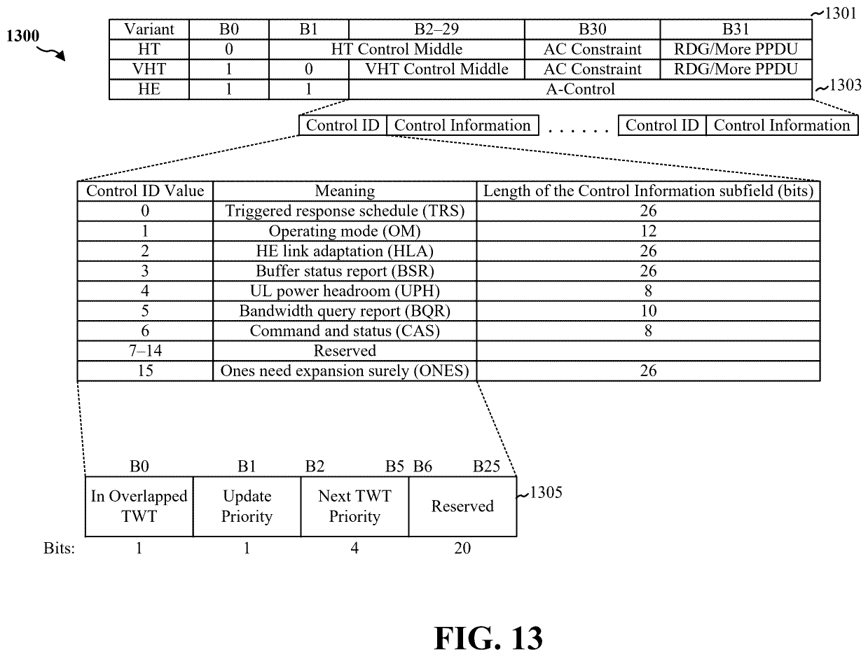

FIG. 13 shows a pictorial diagram 1300 illustrating an example of adding TWT priority update information in frames according to some aspects of the present disclosure. Here, the AP ensures that in the overlapped TWT period, PPDUs with a higher TWT priority value are sent ahead of PPDUs with a lower TWT priority value. In some examples, the AP is responsible for transmitting a MAC frame with TWT Priority Update information in the 30 bit aggregated control (A-Control) field of HE Variant to control which frame of a specific TWT priority can be sent in a particular time of the overlapped TWT.

Specifically, the pictorial diagram 1300 depicts a MAC frame including a high efficiency (HE) variant high-throughput (HT) control field 1301. In some aspects, the HE HT control field includes an A-Control subfield 1303 configured to control transmission of frames in a particular time of the overlapping time period based on a specific priority value. Here, the A-Control subfield 1303 may further include a control identifier (ID) subfield 1305 indicating TWT priority update information. In some cases, the Control ID values 7-14 from the control ID subfield 1305 may be used to define TWT priority update information.

As shown in FIG. 13, a control information subfield associated with the control ID subfield 1305 includes a first subfield (In Overlapped TWT) indicating whether the MAC frame is sent during the overlapping period of not. In some cases, the first subfield indicates a 1 to notify that a current Frame is sent in overlapped TWT part and 0 to notify that the current frame is not sent in overlapped TWT part. When the first subfield indicates a 0 then subsequent parts of the control ID subfield 1305 are ignored. The control ID subfield 1305 also includes a second subfield (Update Priority) indicating whether the TWT priority is triggered. In some cases, the second subfield may indicate a 1 to trigger a TWT priority update (where the new priority is in a third subfield) and may indicate a 0 to trigger no TWT priority update such that subsequent parts of the control ID subfield are ignored. The control ID subfield 1305 further includes a third subfield (Next TWT Priority) indicating an expected or allowed TWT priority of MAC Frames to transmit after the current frame. As mentioned above, the expected priority value is valid when the bit of the second subfield (Update Priority) is 1.

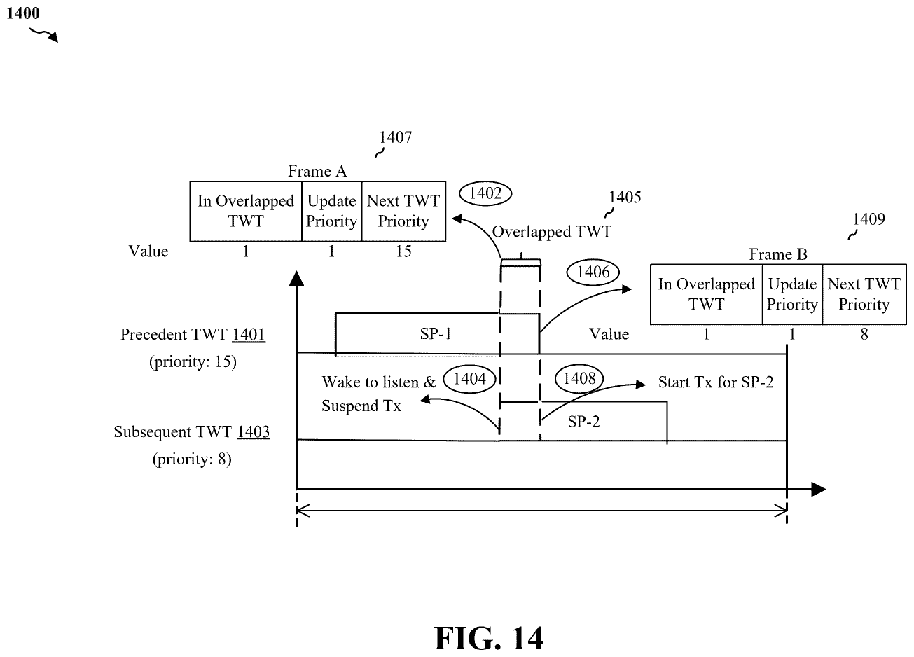

FIG. 14 shows a pictorial diagram 1400 illustrating an example of using TWT priority updates in frames according to a scheduled termination of SP according to some aspects of the present disclosure. In this example, the precedent TWT 1401 has a priority value of 15 and the subsequent TWT 1403 has a priority value of 8, which means that the precedent TWT has priority for transmitting data in the overlapped TWT 1405.

At step 1402, at the start of the overlapped TWT 1405, an AP transmits Frame A 1407 with Control ID subfields for indicating TWT priority update information (as described in FIG. 13) to STAs of precedent TWT 1401. Next, the STAs of precedent TWT 1401 will determine whether it has a matching priority number to a priority number indicated in Frame A 1407. In response to a determination that the STAs of precedent TWT 1401 has a TWT priority value that is equal to the priority number in the third subfield (Next TWT Priority) of the Control ID subfields of Frame A 1407, the STAs of precedent TWT 1401 may continue to transmit data during the overlapped TWT 1405 in SP-1 if appropriate.

At step 1404, STAs of subsequent TWT 1403 wake up to listen and receive Frame A 1407. Next, the STAs of subsequent TWT 1403 will also determine whether its own TWT priority value is equal to the priority number in the third subfield of the Control ID subfields of Frame A 1407. Since the STAs of the subsequent TWT 1403 has a TWT priority value of 8 that does not match the priority value of 15 in the third subfield of the Control ID subfields of Frame A 1407, the STAs of the subsequent TWT 1403 enters a sleep state and suspends Tx during the overlapped TWT 1405.

At step 1406, at the end of the overlapped TWT 1405, the AP transmits Frame B 1409 with Control ID subfields for indicating TWT priority update information (as described in FIG. 13) to STAs of subsequent TWT 1403 that the STAs of subsequent TWT 1403 may initiate Tx.

At step 1408, the STAs of subsequent TWT 1403 receives Frame B 1409 which indicates that the STAs of subsequent TWT 1403 may initiate Tx. In response to a determination that the TWT priority value in Frame B 1409 is equal to the subsequent TWT 1403 priority value in the third subfield (Next TWT Priority) of the control ID subfields of Frame B 1409, the subsequent TWT 1403 may transmit data in SP-2 after the overlapped TWT 1405.

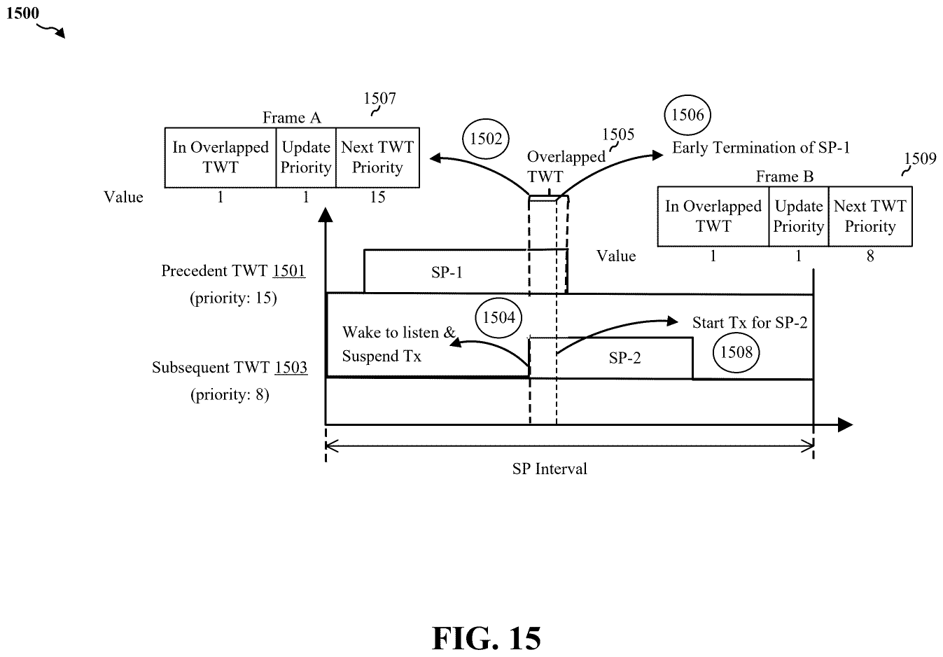

FIG. 15 shows a pictorial diagram 1500 illustrating an example of using TWT priority updates in frames with an early termination of SP according to some aspects of the present disclosure. Here, the precedent TWT 1501 has a priority value of 15 and the subsequent TWT 1503 has a priority value of 8, which means that the precedent TWT has priority over the subsequent TWT 1503 for transmitting data in the overlapped TWT 1505.

At step 1502, at the start of the overlapped TWT 1505, an AP transmits Frame A 1507 with Control ID subfields for indicating TWT priority update information (as described in FIG. 13) to STAs of precedent TWT 1501. In response to a determination that the STAs of precedent TWT 1501 has a TWT priority value that is equal to the priority number in the third subfield (Next TWT Priority) of the Control ID subfields of Frame A 1507, the STAs of precedent TWT 1501 may continue to transmit data during the overlapped TWT 1405 in SP-1.

At step 1504, STAs of subsequent TWT 1503 wake up to receive Frame A 1507. The STAs of subsequent TWT 1503 will determine whether its own TWT priority value is equal to the priority number in the third subfield (Next TWT Priority) of the Control ID subfields of Frame A. Since the STAs of the subsequent TWT 1503 has a TWT priority that does not match the priority value in the third subfield of the control ID subfields of Frame A 1507, the STAs of the subsequent TWT 1503 suspends Tx during the overlapped TWT 1505 and continues listening for notification from the AP to allow the STAs to start Tx.

At step 1506, before the end of the overlapped TWT 1505, the precedent TWT 1501 has no more data to send in SP-1 leading to an early SP termination. The AP transmits a Frame B 1509 with a termination of SP notification (such as End of Service Period (EOSP)=1) to notify STAs of subsequent TWT 1503 that they may begin to initiate Tx.

At step 1508, the STAs of subsequent TWT 1503 receive the Frame B 1509 which indicates that the STAs of subsequent TWT 1503 may initiate Tx. In response to a determination that the TWT priority value in Frame B 1509 is equal to the priority number in the third subfield (Next TWT Priority) of the Control ID subfield of Frame B 1509, the subsequent TWT 1503 may immediately begin Tx in SP-2 even if it is during the overlapped TWT 1505. Therefore, unlike a scheduled termination depicted in FIG. 14, the subsequent TWT 1503 does not have to wait until the end of the overlapped TWT 1505 to begin Tx in SP-2.

FIG. 16 shows a flowchart illustrating an example process performable by a wireless AP that supports overlapping TWTs according to some aspects of the present disclosure. The operations of the process 1600 may be implemented by a wireless AP or its components as described herein. Optional aspects are illustrated in dashed lines. For example, the process 1600 may be performed by a wireless communication device, such as the wireless communication device 200 described with reference to FIG. 2, operating as or within a wireless AP. In some examples, the process 1600 may be performed by a wireless AP such as one of the APs 102 described with reference to FIG. 1.

In some examples, in block 1602, the wireless communication device may transmit a frame including a TWT element indicating a first scheduled SP associated with a first wireless communication device, the first scheduled SP having an overlapping time period with a portion of a second scheduled SP associated with a second wireless communication device. For example, block 1602 may be performed by TWT configuration component 260 from FIG. 2. As another example, as shown in FIG. 8, the precedent TWT 801 has a SP that shares an overlapped TWT 811 with a SP of the subsequent TWT 803. In another example, referring to FIG. 12, the TWT element may indicate a first scheduled SP with an overlapping time period with a portion of a second scheduled SP. In some examples, the TWT element may indicate a priority value for resolving packet conflicts during the overlapping time period. For example, referring to FIG. 13, the A-Control subfield 1303 may include a control ID subfield 1305 indicating a TWT priority update. As another example, referring to FIGS. 14 and 15, Frame A 1407, and 1507 each has a field to indicate a priority value.

In some examples, in block 1604, the wireless communication device may transmit a MAC frame including a HE HT control field, the HE HT control field including an A-Control subfield configured to control transmission of frames in a particular time of the overlapping time period based on a specific priority value. For instance, referring to FIG. 13, the MAC frame may include a HE HT control field 1301 which includes an A-Control subfield 1303 configured to control transmission of frames in a particular time of the overlapping time period using specific priority values. In some examples, the A-Control subfield may include a control ID subfield indicating a TWT priority update. For example, referring to FIG. 13, the A-Control subfield 1303 has a control ID subfield 1305 that indicates a TWT priority update. As another example, referring to FIGS. 14 and 15, the Frame A 1407, and 1507 each have a field indicating an update priority value of 1.

In some examples, a control information subfield associated with the control ID subfield indicating the TWT priority update may include at least: a first subfield indicating whether the MAC frame is sent during the overlapping time period; a second subfield indicating whether the TWT priority update is triggered; and a third subfield indicating an expected priority value for a subsequent MAC frame, the data being received or transmitted during the overlapping time period in the subsequent MAC frame. For example, referring back to FIG. 13, the A-Control subfield 1303 has a first subfield indicating whether the MAC frame is sent during the overlapped time period, a second subfield indicating whether the TWT priority update is triggered, and a third subfield indicating an expected priority value for a subsequent MAC frame. As another example, referring to FIGS. 14 and 15, the Frame A 1407, and 1507 each indicate the different particular subfields described above.

In some examples, the data may be transmitted or received during the overlapping time period within the first scheduled SP in response to a TWT priority value associated with the first scheduled SP matching the expected priority value indicated in the third subfield. As an example, referring to FIGS. 14 and 15, in response to a determination that the STAs of precedent TWTs 1401, and 1501 has a TWT priority value of 15 that is equal to the priority number of 15 in the third subfield (Next TWT Priority) of the Control ID subfields of Frame A 1407, and 1507 the STAs of precedent TWTs 1401, and 1501 may continue to transmit data during the overlapped TWT.

In some examples, the TWT element may include a field indicating whether the overlapping time period is at a beginning of the first scheduled SP or at an end of the first scheduled SP. In some examples, the TWT element may indicate a priority value for resolving packet conflicts during the overlapping time period. In some examples, the TWT element may include a field indicating a time duration of the overlapping time period. For example, referring to FIG. 12, the overlapped TWT field format 1205 indicates whether the overlapping period is at a head or tail of the TWT SP, the priority value for resolving packet conflicts during the overlapped time period, and a time duration of the overlapping time period.

In some examples, in block 1606, the wireless communication device may transmit or receive data during the overlapping time period. For example, 1602 may be performed by TWT component 260.

In some examples, the data may be transmitted or received in a PPDU during the overlapping time period based on a priority value for the physical layer PPDU, where PPDUs with higher priority values are transmitted or received during the overlapping time period before PPDUs with lower priority value. For instance, referring to FIG. 14, the STA of precedent TWT 1401 may transmit data during the overlapped TWT 1405.

In some examples, the first scheduled SP may be associated with a restricted R-TWT. For example, referring back to FIG. 4, the R-TWT extension 403 includes a SP margin 411 to create a longer SP.

In some examples, the wireless communication device may be a wireless AP, the first wireless communication device is a first STA, and the second wireless communication device is a second STA.

FIG. 17 shows a flowchart illustrating an example process performable by a wireless AP that supports overlapping TWTs according to some aspects of the present disclosure. The operations of the process 1700 may be implemented by a wireless AP or its components as described herein. Optional aspects are illustrated in dashed lines. For example, the process 1700 may be performed by a wireless communication device, such as the wireless communication device 200 described with reference to FIG. 2, operating as or within a wireless AP. In some examples, the process 1700 may be performed by a wireless AP such as one of the APs 102 described with reference to FIG. 1.

In some examples, in block 1702, the wireless communication device may transmit a frame including a TWT element indicating a first scheduled SP associated with a first wireless communication device, the first scheduled SP having an overlapping time period with a portion of a second scheduled SP associated with a second wireless communication device.

In some examples, in block 1704, the wireless communication device may transmit or receive data during the overlapping time period.

In some examples, in block 1706, the wireless communication device may transmit a MAC frame indicating a TWT priority update and an expected priority value for a subsequent MAC frame, where the additional data is transmitted or received in the subsequent MAC frame within the second scheduled SP in response to a TWT priority value associated with the second scheduled SP matching the expected priority value. For example, referring back to FIG. 14, the AP transmits Frame B 1409 that notifies STAs of subsequent TWT 1403 may initiate Tx.

In some examples, in block 1708, the wireless communication device may transmit or receive additional data in the second scheduled SP. For example, referring back to FIG. 14, the STAs of subsequent TWT 1403 transmits data in the second scheduled SP in response to TWT priority value of the STAs of the subsequent TWT 1403 matching the expected priority value.

In some examples, the MAC frame may indicate an early termination of the first scheduled SP, and the data may be transmitted or received during a portion of the overlapping time period within the second scheduled SP following the early termination. For example, referring back to FIG. 15, the AP may transmit Frame B 1509 with a termination of SP notification such as EOSP=1 to notify STAs of subsequent TWT 1503 may initiate Tx.

FIG. 18 shows a flowchart illustrating an example process performable by a wireless STA that supports overlapping TWTs according to some aspects of the present disclosure. The operations of the process 1800 may be implemented by a wireless STA or its components as described herein. Optional aspects are illustrated in dashed lines. For example, the process 1800 may be performed by a wireless communication device, such as the wireless communication device 300 described with reference to FIG. 3, operating as or within a wireless STA. In some examples, the process 1800 may be performed by a wireless STA such as one of the STAs 104 described with reference to FIG. 1.

In some examples, in block 1802, the wireless communication device may receive a frame including a TWT element indicating a first scheduled SP associated with an apparatus, the first scheduled SP having an overlapping time period with a portion of a second scheduled SP associated with a second wireless communication device. For example, 1802 may be performed by TWT component 394. For example, as shown in FIG. 8, the precedent TWT 801 has a SP that shares an overlapped TWT 811 with a SP of the subsequent TWT 803. In another example, referring to FIG. 12, the TWT element may indicate a first scheduled SP with an overlapping time period with a portion of a second scheduled SP. In some examples, the TWT element may indicate a priority value for resolving packet conflicts during the overlapping time period. For example, referring to FIG. 13, the A-Control subfield 1303 may include a control ID subfield 1305 indicating a TWT priority update. As another example, referring to FIGS. 14 and 15, the Frame A 1407, and 1507 each indicates a priority value.

In some examples, in block 1804, the wireless communication device may receive a MAC frame including a HE variant HT control field, the HE HT control field including an A-Control subfield configured to control transmission of frames in a particular time of the overlapping time period based on a specific priority value. For instance, referring to FIG. 13, the MAC frame may include a HE HT control field 1301 which includes an A-Control subfield 1303 configured to control transmission of frames in a particular time of the overlapping time period using specific priority values. In some examples, the A-Control subfield may include a control ID subfield indicating a TWT priority update. For example, referring to FIG. 13, the A-Control subfield 1303 has a control ID subfield 1305 that indicates a TWT priority update. As another example, referring to FIGS. 14 and 15, the Frame A 1407, and 1507 each indicate an update priority value of 1.

In some examples, a control information subfield associated with the control ID subfield indicating the TWT priority update may include at least: a first subfield indicating whether the MAC frame is sent during the overlapping time period; a second subfield indicating whether the TWT priority update is triggered; and a third subfield indicating an expected priority value for a subsequent MAC frame, the data being received or transmitted during the overlapping time period in the subsequent MAC frame. For example, referring back to FIG. 13, the A-Control subfield 1303 has a first subfield indicating whether the MAC frame is sent during the overlapped time period, a second subfield indicating whether the TWT priority update is triggered, and a third subfield indicating an expected priority value for a subsequent MAC frame. As another example, referring to FIGS. 14 and 15, the Frame A 1407, and 1507 each indicate the different subfields described above.

In some examples, the data may be transmitted or received during the overlapping time period within the first scheduled SP in response to a TWT priority value associated with the first scheduled SP matching the expected priority value indicated in the third subfield. As an example, referring to FIGS. 14 and 15, in response to a determination that the STAs of precedent TWTs 1401, and 1501 has a TWT priority value of 15 that is equal to the priority number of 15 in the third subfield (Next TWT Priority) of the Control ID subfields of Frame A 1407, and 1507 the STAs of precedent TWTs 1401, and 1501 may continue to transmit data during the overlapped TWT.

In some examples, the TWT element may include a field indicating whether the overlapping time period is at a beginning of the first scheduled SP or at an end of the first scheduled SP. In some examples, the TWT element may indicate a priority value for resolving packet conflicts during the overlapping time period. In some examples, the TWT element may include a field indicating a time duration of the overlapping time period. For example, referring to FIG. 12, the overlapped TWT field format 1205 indicates whether the overlapping period is at a head or tail of the TWT SP, the priority value for resolving packet conflicts during the overlapped time period, and a time duration of the overlapping time period.

In some examples, in block 1806, the wireless communication device may transmit or receive data during the overlapping time period. For instance, referring to FIG. 14, the STA of precedent TWT 1401 may transmit data during the overlapped TWT 1405.

In some examples, the data may be transmitted or received in a PPDU during the overlapping time period based on a priority value for the physical layer PPDU, where PPDUs with higher priority values are transmitted or received during the overlapping time period before PPDUs with lower priority value.

In some examples, the first scheduled SP may be associated with a restricted R-TWT. For example, referring back to FIG. 4, the R-TWT extension 403 includes a SP margin 411 to create a longer SP.

In some examples, the wireless communication device may be a wireless AP, the first wireless communication device is a first STA, and the second wireless communication device is a second STA.

FIG. 19 shows a flowchart illustrating an example process performable by a wireless STA that supports overlapping TWTs according to some aspects of the present disclosure. The operations of the process 1900 may be implemented by a wireless STA or its components as described herein. Optional aspects are illustrated in dashed lines. For example, the process 1900 may be performed by a wireless communication device, such as the wireless communication device 300 described with reference to FIG. 3, operating as or within a wireless STA. In some examples, the process 1900 may be performed by a wireless STA such as one of the STAs 104 described with reference to FIG. 1.

In some examples, in block 1902, the wireless communication device may receive a frame including a TWT element indicating a first scheduled SP associated with a first wireless communication device, the first scheduled SP having an overlapping time period with a portion of a second scheduled SP associated with a second wireless communication device.

In some examples, in block 1904, the wireless communication device may transmit or receive data during the overlapping time period.

In some examples, in block 1906, the wireless communication device may receive a MAC frame indicating a TWT priority update and an expected priority value for a subsequent MAC frame, where the additional data is transmitted or received in the subsequent MAC frame within the second scheduled SP in response to a TWT priority value associated with the second scheduled SP matching the expected priority value. For example, referring back to FIG. 14, STAs of the subsequent TWT 1403 receive Frame B 1409 notifying that the STAs of subsequent TWT 1403 may initiate Tx.

In some examples, in block 1908, the wireless communication device may transmit or receive additional data in the second scheduled SP. For example, referring back to FIG. 14, the STAs of subsequent TWT 1403 transmits data in the second scheduled SP in response to TWT priority value of the STAs of the subsequent TWT 1403 matching the expected priority value.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

### Some Additional Examples

The aspects described herein additionally include one or more of the following implementation examples described in the following numbered clauses.

1. A wireless communication device, including:
at least one memory; and
at least one processor communicatively coupled with the at least one memory, the at least one processor operable to cause the wireless communication device to:
transmit a frame including a target wake time (TWT) element indicating a first scheduled service period (SP) associated with a first wireless communication device, the first scheduled SP having an overlapping time period with a portion of a second scheduled SP associated with a second wireless communication device, and
transmit or receive data during the overlapping time period.

2. The wireless communication device of clause 1, where the TWT element indicates a priority value for resolving packet conflicts during the overlapping time period.

3. The wireless communication device of clause 1 or 2, where the data is transmitted or received in a physical layer protocol data unit (PPDU) during the overlapping time period based on a priority value for the physical layer PPDU, where PPDUs with higher priority values are transmitted or received during the overlapping time period before PPDUs with lower priority values.

4. The wireless communication device of any of the clauses 1 to 3, where the at least one processor is operable to further cause the wireless communication device to:
transmit a medium access control (MAC) frame including a high efficiency (HE) variant high-throughput (HT) control field, the HE HT control field including an aggregated control (A-Control) subfield configured to control transmission of frames in a particular time of the overlapping time period based on a specific priority value.

5. The wireless communication device of any of the clauses 1 to 4, where the A-Control subfield includes a control identifier (ID) subfield indicating a TWT priority update.

6. The wireless communication device of any of the clauses 1 to 5, where a control information subfield associated with the control ID subfield indicating the TWT priority update includes at least:
a first subfield indicating whether the MAC frame is sent during the overlapping time period; a second subfield indicating whether the TWT priority update is triggered; and
a third subfield indicating an expected priority value for a subsequent MAC frame, the data being received or transmitted during the overlapping time period in the subsequent MAC frame.

7. The wireless communication device of any of the clauses 1 to 6, where the data is transmitted or received during the overlapping time period within the first scheduled SP in response to a TWT priority value associated with the first scheduled SP matching the expected priority value indicated in the third subfield.

8. The wireless communication device of any of the clauses 1 to 7, where the TWT element includes a field indicating whether the overlapping time period is at a beginning of the first scheduled SP or at an end of the first scheduled SP.

9. The wireless communication device of any of the clauses 1 to 8, where the first scheduled SP is associated with a restricted TWT (R-TWT).

10. The wireless communication device any of the clauses 1 to 9, where the wireless communication device is a wireless access point (AP), the first wireless communication device is a first wireless station (STA), and the second wireless communication device is a second wireless station (STA).

11. A method for wireless communication performable at a wireless access point, including:
transmitting a frame including a target wake time (TWT) element indicating a first scheduled service period (SP) associated with a first wireless communication device, the first scheduled SP having an overlapping time period with a portion of a second scheduled SP associated with a second wireless communication device; and
transmitting or receiving data during the overlapping time period.

12. The method of clause 11, further including:
transmitting or receiving additional data in the second scheduled SP; and
transmitting a medium access control (MAC) frame indicating a TWT priority update and an expected priority value for a subsequent MAC frame, where the additional data is transmitted or received in the subsequent MAC frame within the second scheduled SP in response to a TWT priority value associated with the second scheduled SP matching the expected priority value.

13. The method of clauses 11 or 12, where the MAC frame further indicates an early termination of the first scheduled SP, and the data is transmitted or received during a portion of the overlapping time period within the second scheduled SP following the early termination.

14. The method of any of the clauses 11 to 13, where the TWT element indicates a priority value for resolving packet conflicts during the overlapping time period.

15. The method of any of the clauses 11 to 14, where the TWT element includes a field indicating a time duration of the overlapping time period.

16. A wireless communication device, including:
at least one memory; and
at least one processor communicatively coupled with the at least one memory, the at least one processor operable to cause the wireless communication device to:
receive a frame including a target wake time (TWT) element indicating a first scheduled service period (SP) associated with an apparatus, the first scheduled SP having an overlapping time period with a portion of a second scheduled SP associated with a second wireless communication device, and
transmit or receive data during the overlapping time period.

17. The wireless communication device of clause 16, where the TWT element indicates a priority value for resolving packet conflicts during the overlapping time period.

18. The wireless communication device of clauses 16 or 17, where the data is transmitted or received in a physical layer protocol data unit (PPDU) during the overlapping time period based on a priority value for the physical layer PPDU, where PPDUs with higher priority values are transmitted or received during the overlapping time period before PPDUs with lower priority values.

19. The wireless communication device of any of the clauses 16 to 18, where the at least one processor is operable to further cause the wireless communication device to:
receive a medium access control (MAC) frame including a high efficiency (HE) variant high-throughput (HT) control field, the HE HT control field including an aggregated control (A-Control) subfield configured to control transmission of frames in a particular time of the overlapping time period based on a specific priority value.

20. The wireless communication device of any of the clauses 16 to 19, where the A-Control subfield includes a control identifier (ID) subfield indicating a TWT priority update.

21. The wireless communication device of any of the clauses 16 to 20, where a control information subfield associated with the control ID subfield indicating the TWT priority update includes at least:
a first subfield indicating whether the MAC frame is sent during the overlapping time period;
a second subfield indicating whether the TWT priority update is triggered; and
a third subfield indicating an expected priority value for a subsequent MAC frame, the data being received or transmitted during the overlapping time period in the subsequent MAC frame.

22. The wireless communication device of any of the clauses 16 to 21, where the data is transmitted or received during the overlapping time period within the first scheduled SP in response to a TWT priority value associated with the first scheduled SP matching the expected priority value indicated in the third subfield.

23. The wireless communication device of any of the clauses 16 to 22, where the TWT element includes a field indicating whether the overlapping time period is at a beginning of the first scheduled SP or at an end of the first scheduled SP.

24. The wireless communication device of any of the clauses 16 to 23, where the first scheduled SP is associated with a restricted TWT (R-TWT).

25. The wireless communication device of any of the clauses 16 to 24, where the wireless communication device is a first wireless station (STA), the apparatus is an access point (AP) and the second wireless communication device is a second wireless station (STA).

26. A method for wireless communication performable at a wireless station, including:
receiving a frame including a target wake time (TWT) element indicating a first scheduled service period (SP) associated with an apparatus, the first scheduled SP having an overlapping time period with a portion of a second scheduled SP associated with a second wireless communication device; and
transmitting or receiving data during the overlapping time period.

27. The method of clause 26, further including:
transmitting or receive additional data in the second scheduled SP; and
receiving a medium access control (MAC) frame indicating a TWT priority update and an expected priority value for a subsequent MAC frame, where the additional data is transmitted or received in the subsequent MAC frame within the second scheduled SP in response to a TWT priority value associated with the second scheduled SP matching the expected priority value.

28. The method of the clause 26 or 27, where the MAC frame further indicates an early termination of the first scheduled SP, and the data is transmitted or received during a portion of the overlapping time period within the second scheduled SP following the early termination.

29. The method of any of the clauses 26 to 28, where the TWT element indicates a priority value for resolving packet conflicts during the overlapping time period.

30. The method of any of the clauses 26 to 29, where the TWT element includes a field indicating a time duration of the overlapping time period.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. A wireless communication device, comprising:
at least one memory; and
at least one processor communicatively coupled with the at least one memory, the at least one processor operable to cause the wireless communication device to:
transmit a frame including a target wake time (TWT) element indicating a first scheduled service period (SP) associated with a first wireless communication device, the first scheduled SP having an overlapping time period with a portion of a second scheduled SP associated with a second wireless communication device, and
transmit or receive data during the overlapping time period.

2. The wireless communication device of claim 1, wherein the TWT element indicates a priority value for resolving packet conflicts during the overlapping time period.

3. The wireless communication device of claim 1, wherein the data is transmitted or received in a physical layer protocol data unit (PPDU) during the overlapping time period based on a priority value for the physical layer PPDU, wherein PPDUs with higher priority values are transmitted or received during the overlapping time period before PPDUs with lower priority values.

4. The wireless communication device of claim 1, wherein the at least one processor is operable to further cause the wireless communication device to:
transmit a medium access control (MAC) frame including a high efficiency (HE) variant high-throughput (HT) control field, the HE HT control field including an aggregated control (A-Control) subfield configured to control transmission of frames in a particular time of the overlapping time period based on a specific priority value.

5. The wireless communication device of claim 4, wherein the A-Control subfield includes a control identifier (ID) subfield indicating a TWT priority update.

6. The wireless communication device of claim 5, wherein a control information subfield associated with the control ID subfield indicating the TWT priority update includes at least:
a first subfield indicating whether the MAC frame is sent during the overlapping time period;
a second subfield indicating whether the TWT priority update is triggered; and
a third subfield indicating an expected priority value for a subsequent MAC frame, the data being received or transmitted during the overlapping time period in the subsequent MAC frame.

7. The wireless communication device of claim 6, wherein the data is transmitted or received during the overlapping time period within the first scheduled SP in response to a TWT priority value associated with the first scheduled SP matching the expected priority value indicated in the third subfield.

8. The wireless communication device of claim 1, wherein the TWT element includes a field indicating whether the overlapping time period is at a beginning of the first scheduled SP or at an end of the first scheduled SP.

9. The wireless communication device of claim 1, wherein the first scheduled SP is associated with a restricted TWT (R-TWT).

10. The wireless communication device of claim 1, wherein the wireless communication device is a wireless access point (AP), the first wireless communication device is a first wireless station (STA), and the second wireless communication device is a second wireless station (STA).

11. A method for wireless communication performable at a wireless access point, comprising:
transmitting a frame including a target wake time (TWT) element indicating a first scheduled service period (SP) associated with a first wireless communication device, the first scheduled SP having an overlapping time period with a portion of a second scheduled SP associated with a second wireless communication device; and
transmitting or receiving data during the overlapping time period.

12. The method of claim 11, further comprising:
transmitting or receiving additional data in the second scheduled SP; and
transmitting a medium access control (MAC) frame indicating a TWT priority update and an expected priority value for a subsequent MAC frame, wherein the additional data is transmitted or received in the subsequent MAC frame within the second scheduled SP in response to a TWT priority value associated with the second scheduled SP matching the expected priority value.

13. The method of claim 12, wherein the MAC frame further indicates an early termination of the first scheduled SP, and the data is transmitted or received during a portion of the overlapping time period within the second scheduled SP following the early termination.

14. The method of claim 11, wherein the TWT element indicates a priority value for resolving packet conflicts during the overlapping time period.

15. The method of claim 11, wherein the TWT element includes a field indicating a time duration of the overlapping time period.

16. A wireless communication device, comprising:
at least one memory; and
at least one processor communicatively coupled with the at least one memory, the at least one processor operable to cause the wireless communication device to:
receive a frame including a target wake time (TWT) element indicating a first scheduled service period (SP) associated with an apparatus, the first scheduled SP having an overlapping time period with a portion of a second scheduled SP associated with a second wireless communication device, and
transmit or receive data during the overlapping time period.

17. The wireless communication device of claim 16, wherein the TWT element indicates a priority value for resolving packet conflicts during the overlapping time period.

18. The wireless communication device of claim 16, wherein the data is transmitted or received in a physical layer protocol data unit (PPDU) during the overlapping time period based on a priority value for the physical layer PPDU, wherein PPDUs with higher priority values are transmitted or received during the overlapping time period before PPDUs with lower priority values.

19. The wireless communication device of claim 16, wherein the at least one processor is operable to further cause the wireless communication device to:
receive a medium access control (MAC) frame including a high efficiency (HE) variant high-throughput (HT) control field, the HE HT control field including an aggregated control (A-Control) subfield configured to control transmission of frames in a particular time of the overlapping time period based on a specific priority value.

20. The wireless communication device of claim 19, wherein the A-Control subfield includes a control identifier (ID) subfield indicating a TWT priority update.

21. The wireless communication device of claim 20, wherein a control information subfield associated with the control ID subfield indicating the TWT priority update includes at least:
a first subfield indicating whether the MAC frame is sent during the overlapping time period;
a second subfield indicating whether the TWT priority update is triggered; and
a third subfield indicating an expected priority value for a subsequent MAC frame, the data being received or transmitted during the overlapping time period in the subsequent MAC frame.

22. The wireless communication device of claim 21, wherein the data is transmitted or received during the overlapping time period within the first scheduled SP in response to a TWT priority value associated with the first scheduled SP matching the expected priority value indicated in the third subfield.

23. The wireless communication device of claim 22, wherein the TWT element includes a field indicating whether the overlapping time period is at a beginning of the first scheduled SP or at an end of the first scheduled SP.

24. The wireless communication device of claim 19, wherein the first scheduled SP is associated with a restricted TWT (R-TWT).

25. The wireless communication device of claim 19, wherein the wireless communication device is a first wireless station (STA), the apparatus is an access point (AP) and the second wireless communication device is a second wireless station (STA).

26-30. (canceled)
